(19) United States
(12) Patent Application Publication
(10) Pub. No.: US 2006/0072588 A1
(43) Pub. Date: Apr. 6, 2006

(54) Voice message service method for providing two-way communication between client computers and messenger device for the same

(75) Inventors: Tae bum Kim, Gunpo-si (KR); Soo Hur, Suwon-si (KR); Jang Hyun Cho, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: 3Rsoft Inc., Seoul (KR)

(21) Appl. No.: 10/943,971

(22) Filed: Sep. 20, 2004

(51) Int. Cl. H04L 12/56

(52) U.S. Cl. 370/400; 370/352

(57) ABSTRACT

A voice message service method for establishing voice message communication between transmission and reception client computers capable of storing/reproducing voice information, and a messenger for the same. A management server is connected between the transmission and reception client computers, and requests a call connection transaction from the reception client computer, such that it conducts voice communication only when the voice communication is requested by a user of the reception client computer desires. The voice data is divided into a plurality of packets, and the voice data packets are transmitted by a TCP connection. Therefore, the interruption of voice data is prevented, resulting in increased data transmission reliability.

### BACKGROUND OF THE INVENTION

1. Field of the Invention

The present invention relates to a voice message service method and a messenger device for the same, and more particularly to a voice message service method for providing two-way communication between client computers and a messenger device for the same, which are initiated by user events such as mouse clicking or keystroke operations carried out by a user, and store/transmit a voice message over the Intemet, resulting in reliable two-way communication of the voice message.

2. Description of the Related Art

With the increasing development of communication technologies provided between users or terminals over the Intemet, not only E-mail services, but also instant message services using a variety of messenger programs have been widely used. The aforementioned services can carry out transmission/reception of an SMS (Short Message Service) message between users or subscribers who execute a variety of tasks using their personal computers (PCs).

There have recently been proposed network solution technologies for establishing an SMS chatting service and real-time two-way voice communication by applying a VoIP (Voice over Internet Protocol) technique for voice communication over the Internet to a messenger service. Also, recent voice communication services establish voice data packet communication between users or subscribers on the condition that a communication path is formed between the users or subscribers.

However, the aforementioned conventional voice communication service immediately transmits user's voice information to a counterpart computer, such that it has a disadvantage in that the user cannot retract his or her misstatement. Also, the conventional voice communication service uses a protocol such as a UDP (User Datagram Protocol)—based RTP (Real-Time Protocol) in consideration of a packet transmission speed, so that data transmission may be unexpectedly interrupted, resulting in unreliable data transmission.

In order to solve the above problems of the conventional voice communication service, there has recently been proposed a new method for one-sidedly transmitting a voice message to a party in the same manner as a conventional SMS message transmission scheme. However, the above method is different from a two-way communication scheme, such that unexpected SMS messages such as stalking or lascivious messages are unavoidably transmitted to users or subscribers.

In order to solve the aforementioned problems, there must be developed an improved voice message transmission solution for establishing voice communication according to intentions of both clients (i.e., transmission and reception users), and transmitting input voice information according to the action of the transmission user. Also, there is needed another voice message transmission solution for generating no lost data packets during voice message transmission.

### SUMMARY OF THE INVENTION

Therefore, the present invention has been made in view of the above problems, and it is an object of the invention to provide a voice message service method and a messenger device for the same, which conduct a session according to request and acceptance signals between corresponding clients, such that the clients can prevent undesired voice messages from being transmitted or received as needed.

It is another object of the invention to provide a voice message service method and a messenger device for the same, which conduct a session according to event information generated by a user after temporarily storing voice information, resulting in a guarantee of reliable data transmission.

In accordance with one aspect of the present invention, these objects are accomplished by providing a voice message service method for use in a system including transmission and reception client computers capable of storing/reproducing voice information, and a management server having access to the transmission and reception client computers, comprising the steps of: processing a session in which the session processing step comprises the steps of: transmitting, by the transmission client computer, a call connection request message to the management server; transmitting, by the management server, the call connection request message to the reception client computer; and opening, by the management server, the session between the transmission and reception client computers according to an acceptance event which is responsive to the call connection request message, and is generated from the reception client computer; and

transmitting a voice message in which the voice message transmission step comprises the steps of: storing voice data corresponding to the voice message in the transmission client computer in the form of a plurality of packets, when a user of the transmission client computer generates a recording event and enters the voice message using an entry unit; transmitting the voice data divided into the plurality of packets to the reception client computer, when the user of the transmission client computer generates a transmission event using the entry unit; and assembling, by the reception client computer, the voice data packets, and reproducing the voice message.

In accordance with another aspect of the present invention, there is provided a voice message service method for use in a system including transmission and reception client computers capable of storing/reproducing voice information, and a management server having access to the transmission and reception client computers, comprising the steps of: processing a session wherein the session processing step comprises the steps of: transmitting, by the transmission client computer, a call connection request message to the management server; transmitting, by the management server, the call connection request message to the reception client computer; and opening, by the management server, the session between the transmission and reception client computers according to an acceptance event which is responsive to the call connection request message, and is generated from the reception client computer; and transmitting a voice message wherein the voice message transmission step comprises the steps of: transmitting voice data corresponding to the voice message to the management server in the form of a plurality of packets, and storing the voice data packets in the management server, when a user of the transmission client computer generates a recording event and enters the voice message using an entry unit; retrieving the voice data packets from the management server, and transmitting the retrieved voice data packets to the reception client computer, when the user of the transmission client computer generates a transmission event using the entry unit; and assembling, by the reception client computer, the voice data packets, and reproducing the voice message.

In accordance with yet another aspect of the present invention, there is provided a voice message service method for use in a system including transmission and reception client computers capable of storing/reproducing voice information, and a management server having access to the transmission and reception client computers, comprising the steps of: processing a session in which the session processing step comprises the steps of: transmitting, by the transmission client computer, a call connection request message to the management server; transmitting, by the management server, the call connection request message to the reception client computer, and opening, by the management server, the session between the transmission and reception client computers according to an acceptance event which is responsive to the call connection request message, and is generated from the reception client computer; and transmitting a voice message in which the voice message transmission step comprises the steps of: storing voice data corresponding to the voice message in the transmission client computer in the form of a plurality of packets, when a user of the transmission client computer generates a recording event and enters the voice message using an entry unit; transmitting the voice data divided into the plurality of packets to the management server, when the user of the transmission client computer generates a transmission event using the entry unit; transmitting, by the management server, the voice data packets to the reception client computer; assembling, by the reception client computer, the voice data packets, and reproducing the voice message.

Preferably, the voice message service method may further comprises the steps of transmitting, by one of the transmission and reception client computers, a call termination request message to the management server; transmitting, by the management server, the call termination request message to the other one of the transmission and reception client computers; and closing, by the management server, the session between the transmission and reception client computers according to an acceptance event responsive to the call termination request message.

In accordance with yet another aspect of the present invention, there is provided a messenger device installed in each of transmission and reception client computers capable of processing a session using a management server, comprising: an event transmitter for transmitting an event generated by a user to the management server upon receiving a call connection request message and a call termination request message from the management server; a voice storage unit for storing voice data corresponding to a voice message in the transmission client computer, when a user of the transmission client computer generates a recording event and enters the voice message using an entry unit; a packet transmitter for transmitting the voice data divided into a plurality of packets to the reception client computer according to a transmission event, when the user of the transmission client computer generates the transmission event using the entry unit; and a reproduction unit for assembling response voice data packets received from the reception client computer, and reproducing a response voice message.

### BRIEF DESCRIPTION OF THE DRAWINGS

The above objects, and other features and advantages of the present invention will become more apparent after reading the following detailed description when taken in conjunction with the drawings, in which:

FIG. 1 is a block diagram illustrating an overall system for implementing a voice message service method in accordance with the present invention;

FIG. 2A is a block diagram illustrating a plurality of functional modules contained in a management server of FIG. 1 in accordance with the present invention;

FIG. 2B is a block diagram illustrating a plurality of functional modules contained in a client computer of FIG. 1 in accordance with the present invention;

FIG. 3 is a flow chart illustrating operations of a call connection process in accordance with the present invention;

FIG. 4 is a flow chart illustrating operations of a call drop case in which a call connection state is not established;

FIG. 5 is a conceptual diagram illustrating a voice packet transmission/reception process based on the P2P (Peer-to-Peer) scheme in accordance with the present invention;

FIG. 6 is a flow chart illustrating operations of a voice message transmission/reception process based on the P2P scheme in accordance with a preferred embodiment of the present invention;

FIG. 7 is a flow chart illustrating operations of a call termination process in accordance with the present invention;

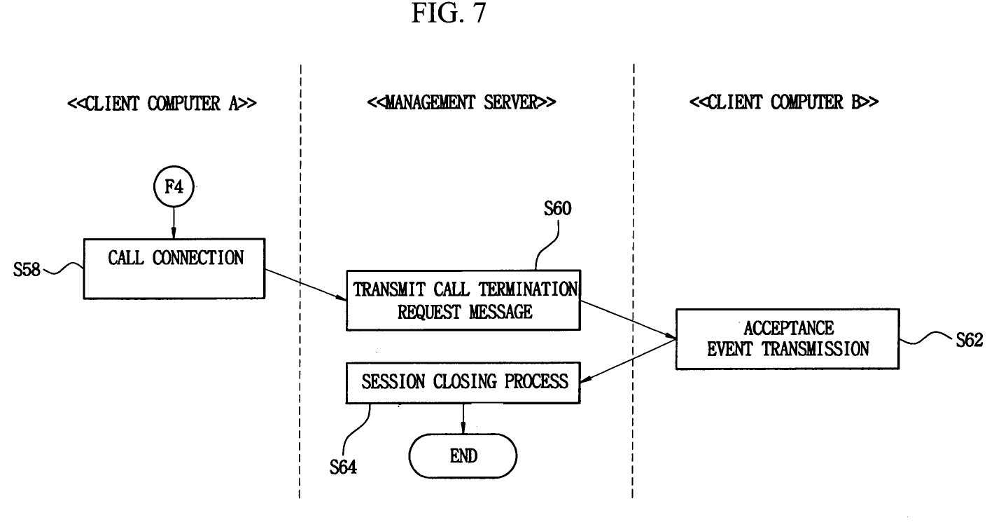

FIG. 8 is a flow chart illustrating operations of a voice packet transmission/reception process using the management server in accordance with the present invention; and

FIG. 9 is a flow chart illustrating operations of a voice message transmission/reception process when a firewall system is implemented in a client computer in accordance with another preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and conFIGurations incorporated herein will be omitted when it may make the subject matter of the present invention rather unclear.

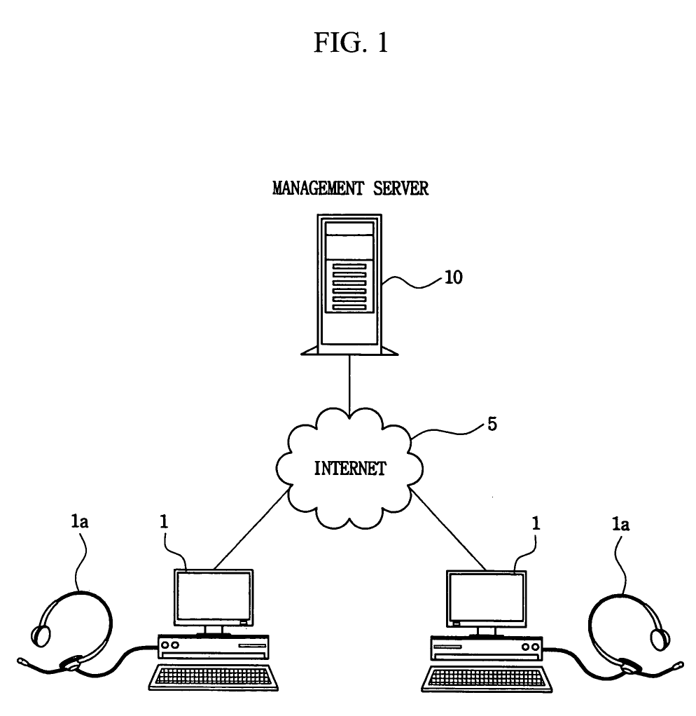

FIG. 1 is a block diagram illustrating an overall system for implementing a voice message service method in accordance with the present invention. Referring to FIG. 1, the present invention is implemented with a system including a plurality of client computers 1, which gain access to a management server 10 over the Internet, and the management server 10 connected between the client computers 1. In accordance with the present invention, the client computer 1 may function as a calling computer (i.e., transmission computer), and may also function as a called computer (i.e., reception computer). The following descriptions will be described on the assumption that a computer for transmitting a voice message is called a transmission client computer.

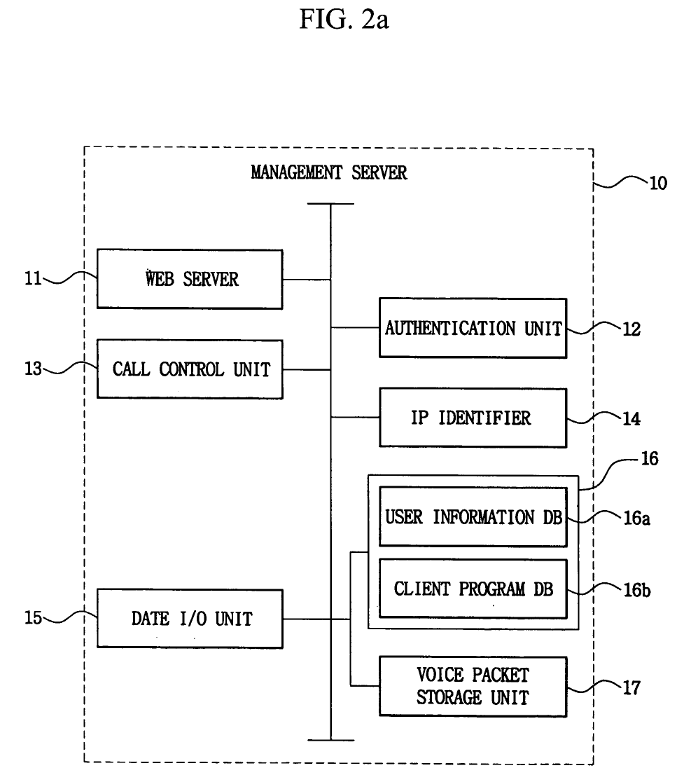

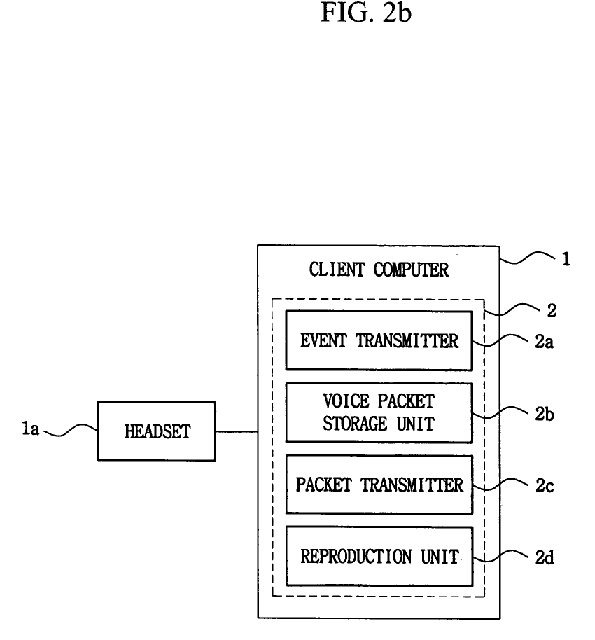

The management server 10 provides the client computers 1 with a voice message messenger. The management server 10 registers user information, authenticates the registered user information, and conducts a call connection process between the client computers 1 upon receiving a request signal from a user. In order to perform the aforementioned operations, as shown in FIG. 2A, the management server 10 includes a web server 11 for providing each client computer with a Web page image for not only inviting a user of the client computer to gain membership, but also introducing inventive services to the user, an authentication unit 12 for authenticating user information, a call control unit 13 for managing a call connection operation between the client computers 1, an IP (Internet Protocol) identifier 14, a data I/O (Input/Output) unit 15, and a DB (Database) 16 for storing 10 data generated by the data I/O unit 15. Also, the management server 10 may further include a voice packet storage unit 17 for temporarily storing voice packet(s).

The call control unit 13 transmits a call connection request message to a reception client computer corresponding to an IP address. If the transmitted call connection message is accepted, the call control unit 13 conducts session-opening and session-maintenance transactions between both client computers.

The IP identifier 14 receives call connection request data from the transmission client computer, and reads ID information such as a user ID of the reception client computer from the received call connection request data. The IP identifier 14 searches for IP address data corresponding to the read ID from a user information DB 16a contained in the DB 16.

The DB 16 includes the user information DB 16a for storing information fields of a user who registers as a member in a voice message service, and a client program DB 16b for storing a messenger adapted to allow the client computers to be interoperable with each other. The user information DB 16a includes an information field for storing personal and ID information of the user registered in the voice message service, and another information field for storing a unique IP address of each client computer.

FIG. 2B is a block diagram illustrating a plurality of functional modules contained in the client computer of FIG. 1 in accordance with the present invention.

Referring to FIG. 2B, the client computer 1 is indicative of a PC (Personal Computer) connected to the Internet 5 over a communication interface or a PDA (Personal Digital Assistant) connected to the Internet 5 over a network such as a wireless LAN. The client computer 1 is equipped with a headset 1a comprised of a microphone and a speaker to carry out I/O operations of a voice signal.

A messenger 2 downloaded from the management server 10 is installed in the client computer 1. The messenger 2 includes an event transmitter 2a, a voice storage unit 2b, a packet transmitter 2c, and a reproduction unit 2d.

The event transmitter 2a transmits call connection request, acceptance, and termination events generated by a user of the client computer to the management server 10 in order to establish a call connection state.

When a recording event is generated by the user who uses an entry unit such as a mouse or keyboard, the voice storage unit 2b temporarily stores input voice data in a memory (not shown) contained in the client computer 1. In this case, the voice storage unit 2b compresses the voice data using a general voice compression technique, divides the voice data into a plurality of packets using a predetermined device such as a PAD (Packet Assembler/Disassembler), and stores the resultant voice data.

When a transmission event is generated by the user who uses an entry unit such as a mouse or keyboard, the packet transmitter 2c retrieves the voice data divided into a plurality of packets from the memory. The packet transmitter 2c transmits the retrieved voice data to the reception client computer 1 or the management server 10 over a pre-opened session.

The reproduction unit 2d is indicative of a module for reproducing a voice message received from the counterpart client computer 1. The reproduction unit 2d includes a pad for assembling the divided voice data packets received from the counterpart client computer 1, and a decompression unit, etc.

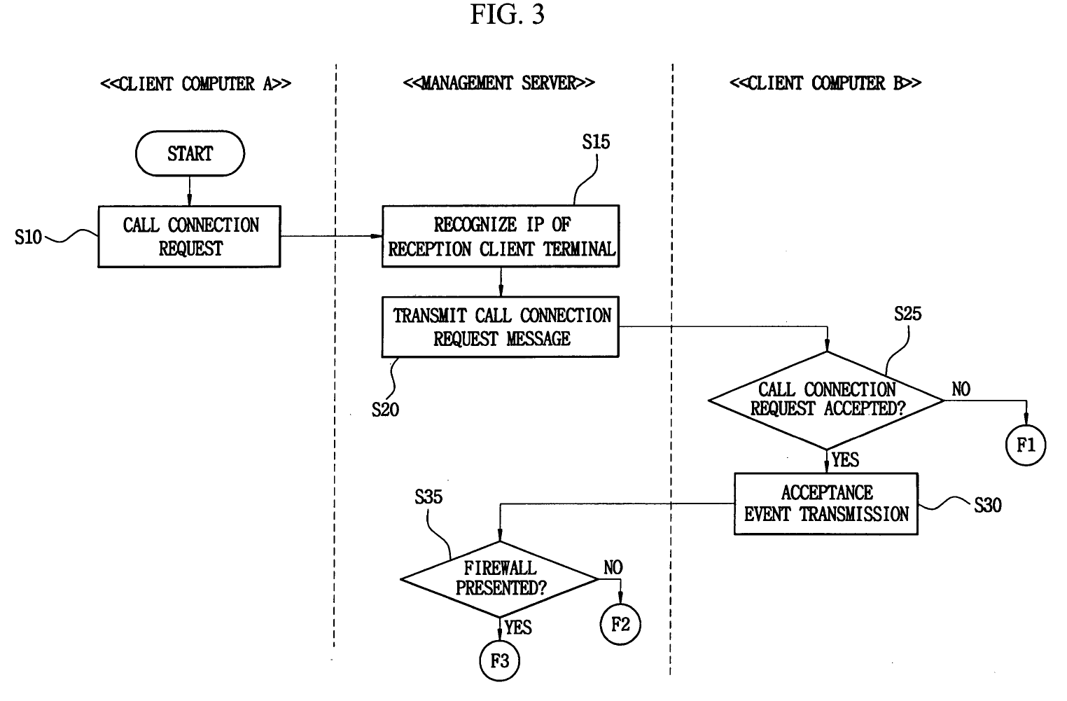

A voice message service method according to the present invention will hereinafter be described with reference to FIGS. 3˜9. FIG. 3 is a flow chart illustrating operations of a call connection process in accordance with the present invention.

Referring to FIG. 3, a first user of the client computer A, who desires to verbally communicate with a second user of the client computer B, transmits a call connection request to the management server 10 at step S10. Upon receipt of the call connection request, the IP identifier 14 of the management server 10 recognizes an IP address of the client computer B acting as a reception end by reading user data stored in the user information DB 16a at step S15.

The call control unit 13 of the management server 10 transmits a call connection request message to the client computer B having the recognized IP address at step S20. In this case, the call control unit 13 also transmits information such as a user ID of the transmission client computer A having transmitted the call connection request to the client computer B.

The user of the client computer B determines the acceptance or denial of the call connection request message at step S25.

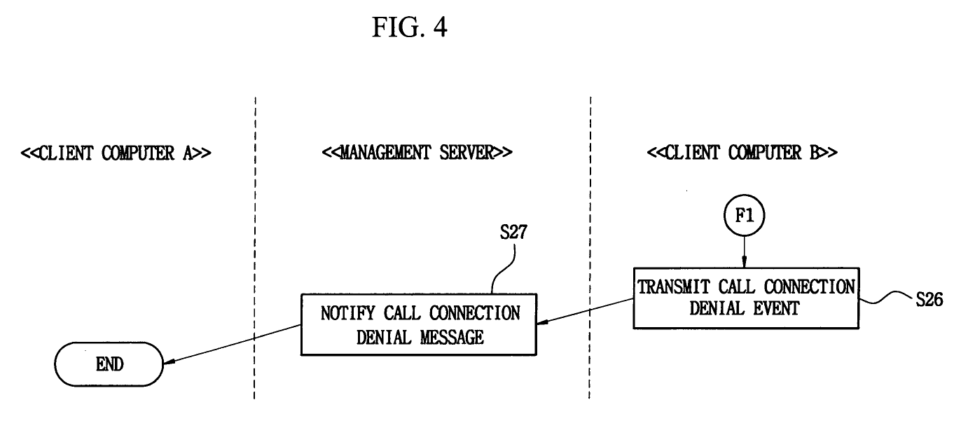

Referring to FIG. 4, if the user of the client computer B does not desire to verbally communicate with the other user of the client computer A, the user of the client computer B clicks on an icon indicative of “Denial” on a display window of the messenger, so that a call connection denial event is transmitted to the management server 10 at step S26. Upon receipt of the call connection denial event, the management server 10 informs the client computer A of a call connection denial message at step S27.

If the user of the client computer B desire to establish voice message communication with the other user of the client computer A, the user of the client computer B clicks on an icon indicative of “Acceptance” on the display window of the messenger. Therefore, the call connection acceptance event is transmitted to the management server 10 over the event transmitter 2a contained in the messenger at step S30.

If the voice message communication between client computers is accepted by the call connection acceptance event, the management server 10 determines the presence or absence of a firewall system in either the client computer A or the client computer B at step S35.

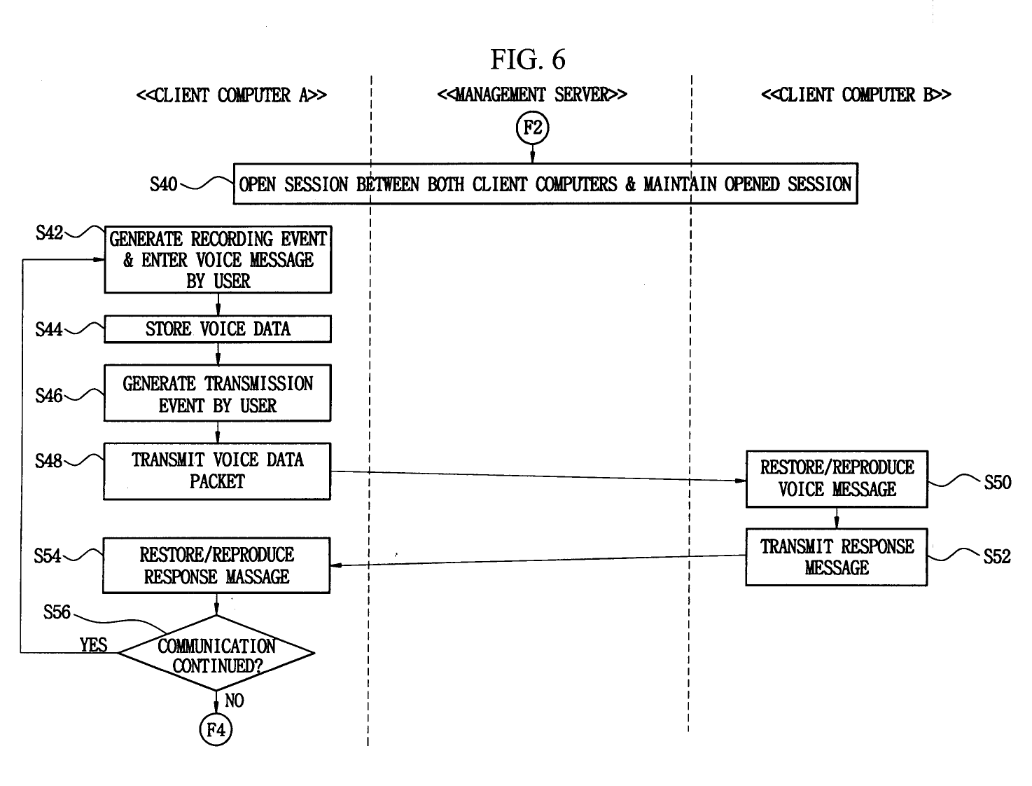

If there is no firewall system in the client computer A or B, the management server 10 opens a session between both client computers as shown in FIG. 6, and maintains the opened session at step S40. It should be noted that the firewall system can include not only a well-known firewall system, but also a security unit such as an NAT (Network Address Translation) if needed.

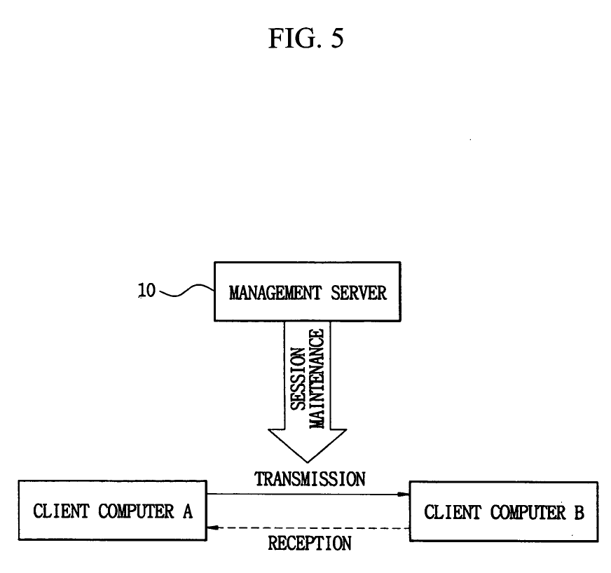

FIG. 5 is a conceptual diagram illustrating a voice packet transmission/reception method based on the P2P (Peer-to-Peer) scheme in accordance with the present invention. A session between the client computers A and B is opened by a TCP(Transmission Control Protocol) connection, such that reliable voice packet transmission is provided.

FIG. 6 is a flow chart illustrating operations of a voice message transmission/reception process based on the P2P scheme in accordance with a preferred embodiment of the present invention. Referring to FIG. 6, the user of the client computer A clicks on an icon indicative of “Recording” on the display window or presses a function key (e.g., ‘Ctrl’, etc.) on a keyboard so as to generate a recoding event, and at the same time enters his or her voice message at step S42.

The input voice message is compressed and divided into a plurality of voice packets by the voice storage unit 2b of the messenger, such that the resultant voice packets are stored in an internal memory of the client computer A at step S44.

If it is determined that there is no problem in the recorded voice message, the user of the client computer A clicks on an icon indicative of “Transmission”, and generates a transmission event at step s46. The voice data packets stored in the memory of the client computer A are extracted from the memory by the packet transmitter 2c of the messenger, and are then transmitted to the client computer B over a channel, a session of which is opened, at step S48.

As another example of the present invention, the voice message of the user of the client computer A may be stored in the voice packet storage unit 17 of the management server 10 in the form of a voice data packet. In this case, when the user of the client computer A generates a transmission event, the voice data packets are transmitted to the client computer B over the data I/O unit of the management server 10.

The reproduction unit 2d of the messenger for use in the client computer B assembles the received voice data packets, decompresses the assembled voice data packets, and reproduces a voice message using a voice output unit such as a headset speaker at step S50. The voice message may be immediately reproduced after the voice data packets are assembled and decompressed, and may also be reproduced when the user of the client computer B clicks on an icon indicative of “Reproduction” on the display window.

The user of the client computer B enters a response message in the same manner as in the aforementioned voice message transmission method for use in the client computer A, and transmits the response message to the client computer at step S52. The response message conFIGured in the form of voice data packets is transmitted to the client computer A at step S52, is assembled, decompressed, and reproduced by the reproduction unit 2d of the client computer A at step S54. The aforementioned method for transmitting/reproducing the response message is the same as that of the client computer A, so its detailed description will be omitted for the convenience of description.

The voice message communication is carried out over a communication channel between the client computers according to the aforementioned method on the assumption that one of the client computers does not interrupt the voice message communication.

Otherwise, if one of the client computers decides to interrupt the voice message communication, the user of the client computer A or B clicks on an icon indicative of “Termination” on the display window so that a call termination event is generated. The generated call termination event is transmitted to the management server 10 over the event transmitter 2a of the messenger. By the call termination event, the user of the client computer A requests the call connection termination from the management server 10 at step S58. Based on the requested call connection termination, the management server 10 transmits a call termination request message to the client computer B at step S60.

The management server receives a call termination acceptance event from the client computer B at step S62. Upon receipt of the call termination acceptance event, the management server 10 conducts a session closing process to close the opened session between the client computers A and B at step S64.

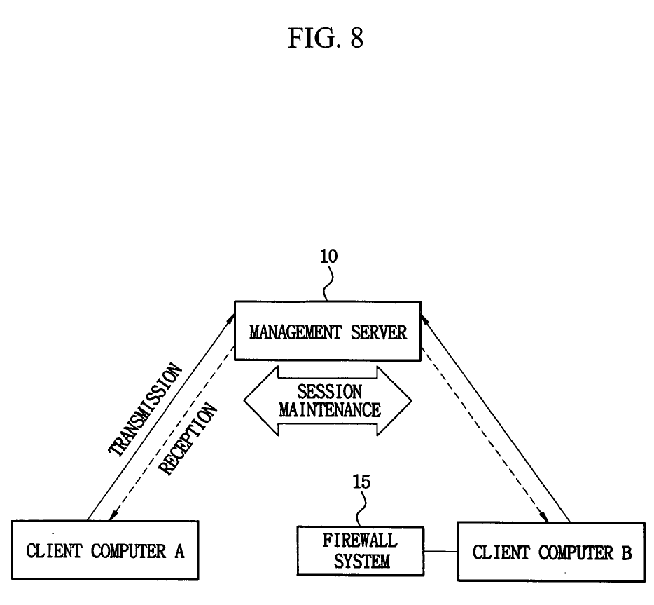

In the meantime, if the client computer A or B includes the firewall system at step S35 of FIG. 2B depicting the voice message service method, transmission/reception operations of the voice message are conducted over the management server 10 as shown in FIG. 8. If one of the client computers includes the firewall system, it prevents the voice data packets from being entered. In this case, a communication port between the management server l and the firewall system is preset to establish voice message communication. Therefore, voice message communication between the management server and each client computer equipped with the firewall system over the preset communication port.

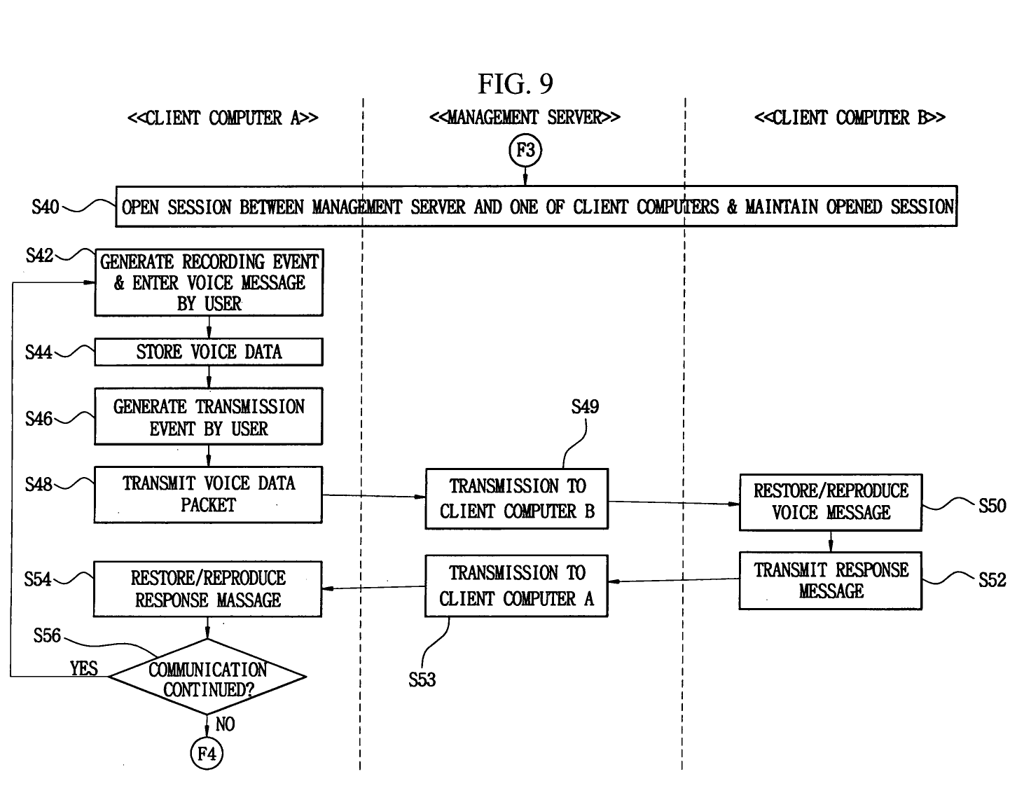

FIG. 9 is a flow chart illustrating operations of a voice message transmission/reception process when a firewall system is implemented in a client computer in accordance with another preferred embodiment of the present invention. Referring to FIG. 9, if the client computer B is equipped with the firewall system, the voice message communication is not directly established between the client computers A and B, but is conducted over the management server 10. The voice message transmission/reception process according to another preferred embodiment of the present invention is the same as that of the aforementioned preferred embodiment of the present invention, so its detailed description will herein be omitted for the convenience of description.

The session between the client computers A and B is opened and maintained at step S41. If the user of the client computer A enters a voice message and transmits the voice message to the management server 10, the management server 10 receives data packets of the voice message. The management server 10 transmits the received voice data packets to the client computer B at step S49.

If the user of the client computer B enters a response message and transmits the response message to the management server 10, the management server 10 receives data packets of the response message. The management server 10 transmits the received response data packets to the client computer A at step S53.

As apparent from the above description, a voice message service method and a messenger device for the same according to the present invention conduct a session according to event information generated by a user after temporarily storing voice information, resulting in a guarantee of reliable data transmission.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A voice message service method for use in a system including transmission and reception client computers capable of storing/reproducing voice information, and a management server having access to the transmission and reception client computers, comprising the steps of:
processing a session in which the session processing step comprises the steps of:
transmitting, by the transmission client computer, a call connection request message to the management server;
transmitting, by the management server, the call connection request message to the reception client computer; and
opening, by the management server, the session between the transmission and reception client computers according to an acceptance event which is responsive to the call connection request message, and is generated from the reception client computer; and
transmitting a voice message in which the voice message transmission step comprises the steps of:
storing voice data corresponding to the voice message in the transmission client computer in the form of a plurality of packets, when a user of the transmission client computer generates a recording event and enters the voice message using an entry unit;
transmitting the voice data divided into the plurality of packets to the reception client computer, when the user of the transmission client computer generates a transmission event using the entry unit; and
assembling, by the reception client computer, the voice data packets, and reproducing the voice message.

2. The voice message service method according to claim 1, further comprising the steps of:
transmitting, by one of the transmission and reception client computers, a call termination request message to the management server;
transmitting, by the management server, the call termination request message to the other one of the transmission and reception client computers; and
closing, by the management server, the session between the transmission and reception client computers according to an acceptance event responsive to the call termination request message.

3. The voice message service method according to claim 1, wherein the call connection between the transmission and reception client computers is established by a TCP connection.

4. A voice message service method for use in a system including transmission and reception client computers capable of storing/reproducing voice information, and a management server having access to the transmission and reception client computers, comprising the steps of:
processing a session wherein the session processing step comprises the steps of:
transmitting, by the transmission client computer, a call connection request message to the management server;
transmitting, by the management server, the call connection request message to the reception client computer; and
opening, by the management server, the session between the transmission and reception client computers according to an acceptance event which is responsive to the call connection request message, and is generated from the reception client computer; and
transmitting a voice message wherein the voice message transmission step comprises the steps of:
transmitting voice data corresponding to the voice message to the management server in the form of a plurality of packets, and storing the voice data packets in the management server, when a user of the transmission client computer generates a recording event and enters the voice message using an entry unit;
retrieving the voice data packets from the management server, and transmitting the retrieved voice data packets to the reception client computer, when the user of the transmission client computer generates a transmission event using the entry unit; and
assembling, by the reception client computer, the voice data packets, and reproducing the voice message.

5. The voice message service method according to claim 4, further comprising the steps of:
transmitting, by one of the transmission and reception client computers, a call termination request message to the management server;
transmitting, by the management server, the call termination request message to the other one of the transmission and reception client computers; and
closing, by the management server, the session between the transmission and reception client computers according to an acceptance event responsive to the call termination request message.

6. The voice message service method according to claim 4, wherein the call connection between the transmission and reception client computers is established by a TCP connection.

7. A voice message service method for use in a system including transmission and reception client computers capable of storing/reproducing voice information, and a management server having access to the transmission and reception client computers, comprising the steps of:
processing a session in which the session processing step comprises the steps of:
transmitting, by the transmission client computer, a call connection request message to the management server;
transmitting, by the management server, the call connection request message to the reception client computer; and
opening, by the management server, the session between the transmission and reception client computers according to an acceptance event which is responsive to the call connection request message, and is generated from the reception client computer; and
transmitting a voice message in which the voice message transmission step comprises the steps of:
storing voice data corresponding to the voice message in the transmission client computer in the form of a plurality of packets, when a user of the transmission client computer generates a recording event and enters the voice message using an entry unit;
transmitting the voice data divided into the plurality of packets to the management server, when the user of the transmission client computer generates a transmission event using the entry unit;
transmitting, by the management server, the voice data packets to the reception client computer;
assembling, by the reception client computer, the voice data packets, and reproducing the voice message.

8. The voice message service method according to claim 7, further comprising the steps of:
transmitting, by one of the transmission and reception client computers, a call termination request message to the management server;
transmitting, by the management server, the call termination request message to the other one of the transmission and reception client computers; and
closing, by the management server, the session between the transmission and reception client computers according to an acceptance event responsive to the call termination request message.

9. The voice message service method according to claim 7, wherein the call connection between the transmission and reception client computers is established by a TCP connection.

10. A messenger device installed in each of transmission and reception client computers capable of processing a session using a management server, comprising:
an event transmitter for transmitting an event generated by a user to the management server upon receiving a call connection request message and a call termination request message from the management server;
a voice storage unit for storing voice data corresponding to a voice message in the transmission client computer, when a user of the transmission client computer generates a recording event and enters the voice message using an entry unit;
a packet transmitter for transmitting the voice data divided into a plurality of packets to the reception client computer according to a transmission event, when the user of the transmission client computer generates the transmission event using the entry unit; and
a reproduction unit for assembling response voice data packets received from the reception client computer, and reproducing a response voice message.

11. The messenger device according to claim 10, wherein the call connection between the transmission and reception client computers is established by a TCP connection.

12. A messenger device installed in each of transmission and reception client computers, each of which has access to a management server and includes a firewall system, comprising:
an event transmitter for transmitting an event generated by a user to the management server upon receiving a call connection request message and a call termination request message from the management server;
a voice storage unit for storing voice data corresponding to a voice message in the transmission client computer, when a user of the transmission client computer generates a recording event and enters the voice message using an entry unit;
a packet transmitter for transmitting the voice data divided into a plurality of packets to the reception client computer according to a transmission event, when the user of the transmission client computer generates the transmission event using the entry unit; and
a reproduction unit for assembling response voice data packets received over the management server after being transmitted from the reception client computer, and reproducing a response voice message.

13. The messenger device according to claim 12, wherein the call connection between the transmission and reception client computers is established by a TCP connection.
